(19) United States
(12) Patent Application Publication
(10) Pub. No.: US 2002/0164004 A1
(43) Pub. Date: Nov. 7, 2002

(54) System and method for providing on-demand responses to inquiries made by information consumers

(76) Inventors: Ronald Tamura, Fremont, CA (US); Tze-Yee Szeto, Santa Cruz, CA (US)

Correspondence Address: DONALD L. BEESON, ONE KAISER PLAZA, SUITE 2360, OAKLAND, CA, 94612, US

(21) Appl. No.: 10/025,970

(22) Filed: Dec. 17, 2001

Related U.S. Application Data
(60) Provisional application No. 60/255,800, filed on Dec. 15, 2000.

(51) Int. Cl. H04M 11/00

(52) U.S. Cl. 379/93.12; 379/93.15

(57) ABSTRACT

A system for providing demand responses to inquiries made by information consumers includes a database having a plurality of stored responses corresponding to inquiries made by an information consumer wherein each of the stored responses contains at least one stored item returnable to an information consumer in response to an inquiry. The returnable item of the stored response is of a preferred presentation media type that most effectively presents the returnable item. A real time inquiry response system receives inquiries submitted by information consumers from devices having a communications interface. Means are provided for correlating the consumer inquiries received by the real time inquiry response system with inquiry responses stored within the database. The system further includes device/interface identification means for identifying the communications interface and the communications device from which the inquiry from the information consumer is sent, and a stored item return means associated with the real time inquiry response system determines whether a media type for a stored item of the inquiry response is compatible with the communications interface and communications device. The item of the stored response is returned to a communications device having the communications interface which is compatible with the media type of the item of the stored inquiry response. The media type of a stored item of the inquiry response can further be transformed to a different transformed media type in response to an inquiry requiring the presentation of the item of the stored response in the transformed media type.

### CROSS-REFERENCE TO RELATED APPLICATIONS

Applicants claim the benefit of provisional application No. 60/255,800, filed Dec. 15, 2000.

### BACKGROUND OF THE INVENTION

The present invention generally relates to the rapid distribution of information and data to information consumers in response to a demand therefore. The invention more particularly relates to providing a facility for responding to information consumer inquiries stimulated by a particular demand stimulus (whether external or internal) and for providing on-demand information and data in useful formats appropriate to the needs of the information consumer and appropriate for delivery to a variety of information receiving devices.

Access to timely information is important to such information consumers as consumers of products and services. Demand for timely information is also important in the enterprise environment where companies need to provide different operational groups, such as their sales force, resource planning people, and purchasing, with access to a wide variety of information that allows them to efficiently perform their tasks. For example, service technicians may need to obtain product specifications or repair bulletins while at a customer site or a salesman may need current promotional literature or price lists for a sales presentation. Difficulties in promptly accessing such information in appropriate formats or the inability to access such information through the variety of communications channels can lead to inefficiency, delays, customer dissatisfaction and lost sales.

In consumer applications, a demand for information can be stimulated by a wide variety of demand stimuli reaching the consumer through a wide variety of stimulus sources and media, and through a wide variety of communication channels. For example, communication channels through which consumer demand for products and services can be generated include television and radio broadcasts, billboard advertising, print ads, such as ads in newspapers, transit ads, magazines, promotional flyers, and electronic ads transmitted over a wide area network or the Internet. The demand stimulated through such a broad spectrum of media can involve a limitless array of products and services, of which the following provide but a few examples. A song played on the radio may stimulate a demand to purchase the song by consumers listening to the radio station on which the song is played. A billboard ad for a product or service may stimulate a demand for the product or service by consumers who see the ad while traveling by the billboard. A television program may stimulate a demand for a transcript of the program or other follow-up information, such as future episodes. A movie schedule printed in a newspaper may stimulate a consumer's desire to see a particular movie listed in the schedule.

All the foregoing examples are examples of external stimuli through which demand for a product or service may arise when the external stimulus (hearing a broadcast, seeing an ad) is encountered. Demand stimuli can also be internal, for example, where a consumer desires to see a movie or attend a concert, or where the consumer desires to read a book by a particular author, or an internally generated desire arises for a particular product or service. (An internal desire might also be stimulated by a referral or recommendation by a friend for a song or a movie.) In the case of all such demand stimuli, whether external or internal, the information consumer normally needs further information and/or incentives to act on the stimulated demand. For example, the consumer may need the title and artist of a song heard on the radio and further secondary information, such as pricing information and locations where recordings of the song can be purchased. Or, in the case of an advertisement, whether broadcast, in print, or on a billboard, transit vehicle, or building, or elsewhere, the consumer may desire to know more information about the product, including an expanded product description, product warranty information, conveniently located vendors for the product, pricing, and available discounts or other sales incentives. Or the information consumer may want further information, such as a movie schedule, reviews, and ticket information.

A wide variety of on-demand sources of information are available to information consumers, including general on-demand information sources and information sources for facilitating the purchase of products and services. For example, U.S. Pat. No. 5,661,787 issued to Michael Pocock discloses a system for on-demand remote access to a self-generating audio recording, storage, and retrieval system, wherein a purchaser who hears a song broadcast over the radio is able to identify the song and artist by calling an 800 number over a touch-tone phone and entering a broadcast identifier which is correlated to a program schedule stored on a central computer. The computer responds to a caller with a voice description of the song title and artist. Other examples include product-ordering websites, such as Amazon.com.

The difficulty with existing facilities for providing on-demand information in response to inquiries from information consumers is that such facilities are generally platform-specific or platform-limited, or otherwise are not adapted to providing information in a format useful to the information consumer or suitable for the communication device used by the information consumer. For example, information regarding a product or service may be available on the provider's website, which is readily accessed by the information consumer's personal computer. However, the information provided from such sites may not be suitable for delivery to other communication devices, such as a telephone, a web enabled (WAP) phone, or other wireless device. Such limitations to on-demand information retrieval at the key point of interest increase the probability that the information consumer will not receive information in a timely manner or will not follow up on a stimulus for information that creates the demand.

Further, information may be available for delivery to an information consumers communications device, but in a format which is unsuitable for the information consumers needs. A repair technician, for example, may call for repair instructions on a WAP phone which he or she may wish to listen to while making a repair, but which can only be delivered to the WAP phone as a text message.

Therefore, a need exists for a system and method for providing on-demand responses to inquiries made by information consumers using a variety of communication interfaces or interfaces (collectively “interfaces”) associated with a variety of communication devices. A further need exists for a system and method for providing on-demand responses to inquiries made by information consumers which permits information to be delivered to a information consumer of a type and in a format most suited to the communications interface and device used by the information consumer, as well as to the particular needs of the information consumer.

### SUMMARY OF THE INVENTION

It is an object of the invention to provide a system and method for providing on-demand responses to information consumers which are not limited to delivering information to specific communications devices or interfaces. It is a further object of the invention to provide a system and method for providing on-demand responses to inquiries in alternative media types which are best suited for delivery to a variety of communications interfaces and devices or best suited to the particular needs or preferences of the information consumer.

Briefly, the system of the invention includes a real time inquiry response system (“RTIRS”) and a database accessible by the RTIRS which has a plurality of stored responses corresponding to inquiries made by an information consumer. Each of the stored inquiry responses contains at least one stored item returnable by the RTIRS to an information consumer in response to an inquiry, with the returnable item being of a preferred presentation media type that most effectively presents the returnable item. In one aspect of the invention, one or more stored inquiry responses have at least two, and perhaps multiple stored items, with each stored item being of a particular media type that most effectively presents the returnable item. As an illustrative example in a consumer application, a stored response for a inquiries about a movie may contain two stored items, a video clip where the media type is video and a discount coupon where the media type is text. An illustrative example in an enterprise application would be such items as a printed repair bulletin stored as a text media type and spoken repair instructions stored as audio.

The RTIRS includes means for correlating inquiries received by the RTIRS with inquiry responses stored in the database, and device-interface identification means for identifying the communications interface and communications device from which the inquiry from the information consumer is sent. The RTIRS still further includes a stored item return means for determining whether the media type for the stored item or items of the inquiry response that is correlated to the incoming inquiry is compatible with the communications interface and communications device from which the inquiry is made, and for subsequently returning the item of the stored response to a communications device having a communications interface which is compatible with the media type of the item of the stored inquiry response.

In a further aspect of the invention, the system of the invention includes media type transforming means cooperative with the stored item return means for transforming the preferred media type of a stored item of the stored inquiry response to a different transformed media type. The media type transforming means is responsive to the means for identifying the communications interface and communications device from which an inquiry is sent and to preferences established by the information consumer or an information provider. When the device-interface identification means identifies a communications interface or communications device which is not compatible with the preferred media type of the item of the stored inquiry response, the transforming means transforms the preferred media type of the stored item of the inquiry response to a transformed media type which is compatible with the communications device and with the communications interface which is the source of the inquiry.

### DESCRIPTION OF THE DRAWINGS

FIG. 1 is a block diagram showing a conceptual overview of a system for providing on-demand responses to inquires from information consumers wherein the illustrated embodiment of the system has an inquiry response database divided into different categories of information.

FIG. 2 is a block diagram showing in greater detail the system depicted in FIG. 1 accessed through a telephone system and the Internet.

FIG. 3 is a graphical depiction of the content of the inquiry response database of the system shown in FIG. 1, showing the database divided into broadcast information and non-broadcast information categories and showing means for updating the database through information providers and a broadcast identification system.

FIG. 4 is a block diagram showing in greater detail the broadcast identification system show in FIG. 3.

FIG. 5 is a flow chart showing a method of providing on demand responses to consumer inquiries generated by a demand stimulus.

FIG. 6 is a flow chart showing a process of registering users of the system through consumer service representatives or IVR prompts.

FIG. 7 is a flow chart illustrating inquiry response follow-up activity including sending follow-up e-mail messages and/or sales incentives to a consumer using the system and giving the consumer an opportunity to purchase a product or service including a possible transfer to a supplier representative.

FIG. 7A is a flow chart illustrating steps for archiving inquiry responses and sending personalized messages to a user making an inquiry.

FIG. 8 is a block diagram illustrating conceptually how the system can by accessed by the information consumer through a variety of communication devices having a variety of communication interfaces.

FIG. 9 is a flow chart showing a method of providing on demand responses to inquiries from information consumers in enterprise as opposed to consumer applications.

FIG. 10 is a block diagram conceptually illustrating the storage of different returnable items within one stored inquiry response in accordance with the invention.

FIG. 11 is a table of transformations of media types for items of a stored response in accordance with the invention, and particularly showing a matrix of possible media type transformations for particular media types.

FIG. 11A is a conceptual block diagram of a transformation hierarchy based on the types of communication devices used to retrieve information from a system.

FIG. 11B is a is a conceptual block diagram illustrating the hardware and software applications that can be used to transform one media type to another.

FIG. 12 is a flow chart illustrating the process of identifying devices and interfaces from which an inquiry is received in order to determine whether an item, or which item, of a stored response can be returned and to trigger a possible transformation of media types.

### DETAILED DESCRIPTION OF THE ILLUSTRATED EMBODIMENT

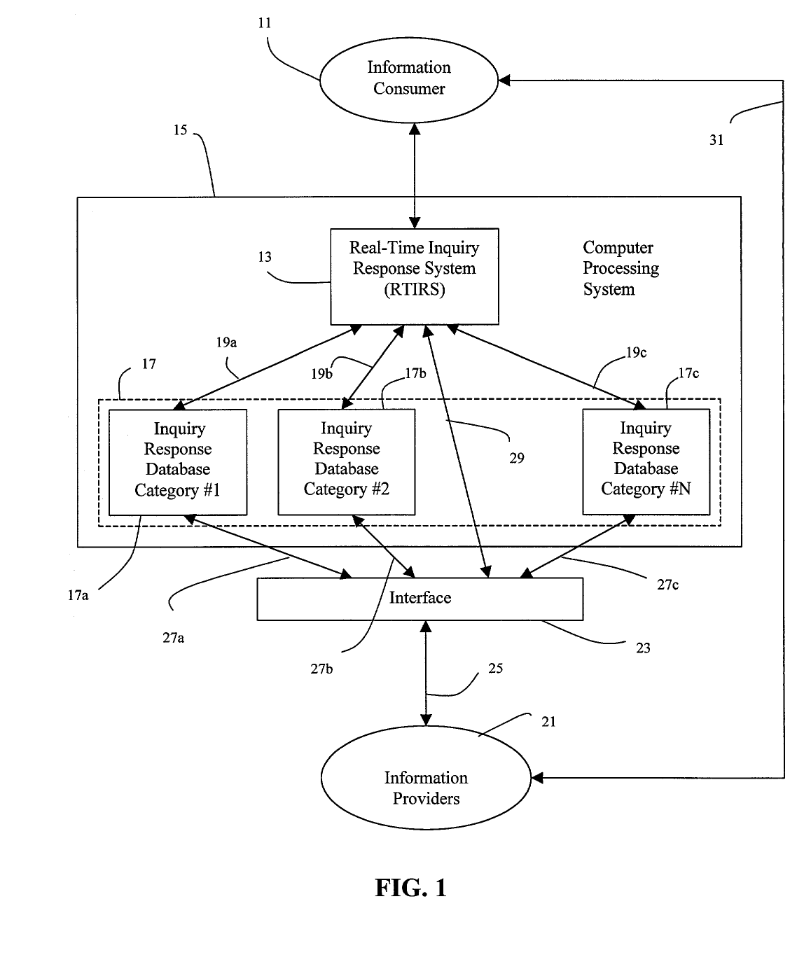

Referring now to the drawings, FIG. 1 provides a conceptual overview of a system which permits an information consumer 11 to interactively communicate with a real time inquiry response system (RTIRS) 13 of a computer processing system 15 having a inquiry response database 17 containing information and data pertaining to different categories of inquiries as represented by blocks 17a, 17b and 17c. While information is shown as being stored in different categories, it will be understood that the invention will encompass a system having a database with data and information stored as a single category only.

The contents of the database 17 are categorized in terms of the different types of media and demand stimuli which stimulate an inquiry from an information consumer. For example, in consumer applications category #1 as represented by block 17a might contain inquiry response information and data pertaining to broadcast music. In this case the database might contain a schedule or “playlist” of broadcast songs by identified broadcasters and stored responses that are correlated to the broadcaster's playlist. When an inquiry is received from an information consumer 11 by the real time inquiry response system 13 which is related to a broadcast song heard by the consumer on the radio or TV, the RTIRS causes the system to respond to the consumer by accessing data, including stored inquiry responses, from the category #1 portion of the inquiry response as represented by data flow arrow 19a. A second category of stored information, as represented by block 17b, might, for example, include data and information pertaining to advertised products wherein an inquiry from information consumer 11 regarding an advertised product or service seen or heard by the consumer can be processed by accessing information and data in the category #2 block of the database as represented by data flow arrow 19b. Still a further example of a category of information and data, represented by block 17c and denoted category “#N,” may be information and data related to movies which a consumer may desire to see, including movie schedules of participating theaters, movie reviews, ticket price information, and/or video tape availability information. Thus, an inquiry pertaining to a movie would be handled by the real time inquiry response system 13 by accessing the category “#N” block of the inquiry response database as represented by data flow arrow 19c. Generally, the database categories are selected and added to the system based on the types of data and data organization and structure peculiar to a given category.

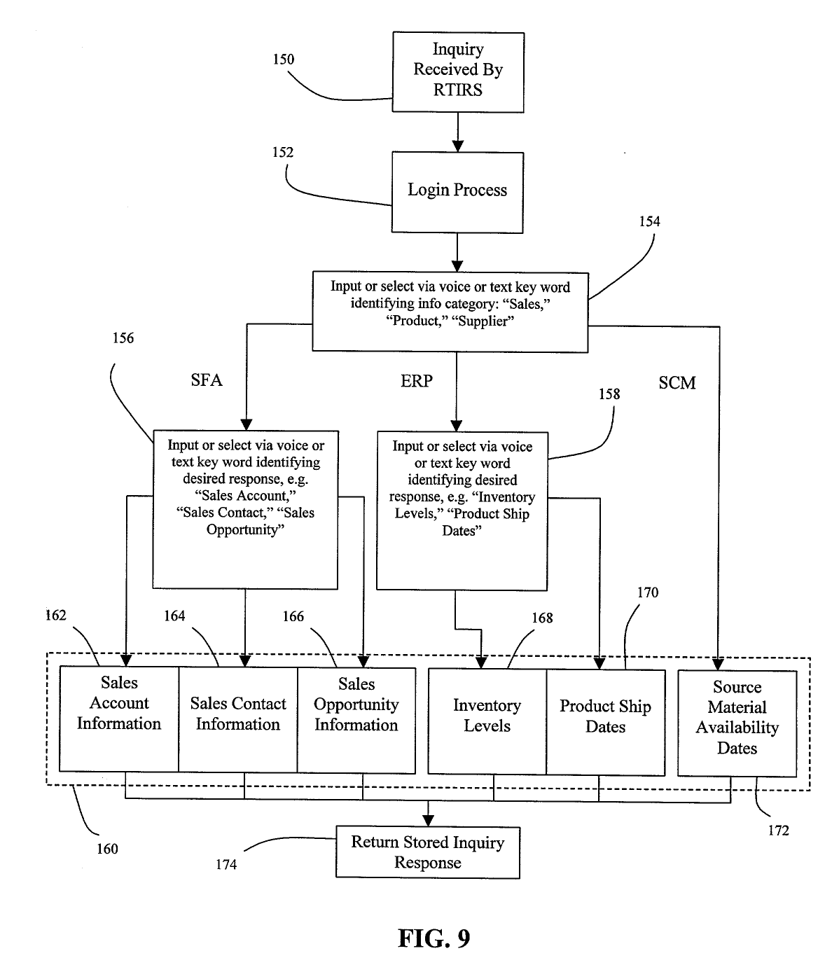

It should here be noted that, as further described below in connection with FIG. 9, the types and organization of information and data are not limited to consumer applications, but can also be adapted to enterprise use. For enterprises, the categories of information might involve information related to enterprise groups broadly defined as “Sales” and “Service, ” where the sales category contains catalog information and current pricing and the service category contains catalog and current pricing information. Other examples of enterprise application categories (illustrated in FIG. 9) would be categories designated “Sales Force Automation” (SFA), “Enterprise Resource Planning” (ERP), and “Supply Chain Management” (SCM). A sales representative might, for example, access the RTIRS and the SFA category of information through a wireless device while stuck in traffic to obtain the phone number of a client. The RTIRS could then hot transfer the sales rep to the client to notify the client that he or she will be late. The ERP category might be used by customer service representatives to obtain a status report on a shipment. The SCM category might, in turn, be used by the purchasing department of the enterprise to check whether the inventory levels of suppliers are sufficient to handle anticipated orders.

It is noted that each category of information and data in database 17 can be divided into subcategories depending on how stored information and data are organized and accessed by the RTIRS. An example of main database categories in consumer applications might be information and data pertaining to external demand stimuli which can be associated with an identifiable source, such as a radio station, TV station, print publication, and possibly even the location of a billboard, and data and information pertaining to demand stimuli which have no identifiable source, such as an internally stimulated desire to see a movie or a concert, or to obtain more information regarding a particular product or service. The subcategories of information within these main categories might in turn pertain to the subject of the inquiry such as a song, advertised product or service, movies and concerts.

FIG. 1 also pictorially illustrates how suppliers of goods and services or other information providers interact with the system and with information consumers who use the system. Generally, information providers, which are represented by block 21, will have access to the computer processing system 15 through an interface 23 which permits communication between different types of data terminal equipment (DTE's). Particularly, data flow links are provided between the information providers and the system's inquiry response database (as represented by data flow arrows 25 and 27a, 27b, 27c), and between the information providers and the real time inquiry response system 13 as represented by arrow 29. Information providers are provided with direct access to the inquiry response database for purposes of supplying information and data, including inquiry responses, to the database and for the purpose of retrieving collected inquiry data related to the information providers' product or service. More specifically, each information provider will have access to the database category to which its product or service pertains. For example, an information provider who is a radio station may supply a broadcast schedule in the form of a playlist, and perhaps further information regarding songs on the playlist, to the category #1 segment of the inquiry response. At the same time, useful inquiry data may be collected on the database which can be retrieved by radio stations, such as the number of requests received by the real time inquiry response system over a defined period of time for the stored songs. Similarly, an advertiser of a product or service may supply ad related information and data to the category #2 database (block 17b) as well as desired stored inquiry responses to the ads, such as a description of the product, product promotions, and retail locations where the product can be purchased. At the same time, collected inquiry data related to the product or service, such as the number of requests for a product or system received by the real time inquiry response system within a specified period of time, can be retrieved by the advertiser.

In yet another example, information providers who are movie theaters may supply the inquiry response, in this case category #N, with movie schedules, ticket prices, and other useful information pertaining to movies selected. In enterprise applications the information providers will normally be the enterprises themselves who will update, for example, their own product and other enterprise information and data in the database.

It is contemplated that more than one information provider could supply data and information to a particular database category which can be aggregated into a predefined inquiry response. For example, theaters could supply movie schedules and ticket prices while newspapers could supply movie reviews related to the movies shown at the theaters. As hereinafter described, it is also contemplated that in certain categories, the stimulus content and responses may be inputted to the database by someone other than the information providers, that is, by someone other than the providers of the goods and services.

It is further noted that data link 29 between the real time inquiry response system and the information providers is shown to indicate that communications can occur directly between the RTIRS and the information providers which may or may not involve retrieval of data from the database 17, such as, in consumer applications, a facility whereby the real time inquiry response system passes inquiry requests from consumers directly to information providers in addition to or instead of returning a stored response to the inquiry from the inquiry response database. The information providers may also want to communicate directly with the RTIRS to indicate content for the databases is available from the information providers, such as new advertisement content.

Finally, FIG. 1 shows a direct communication link 31 between the information consumers and the information providers to permit the information consumers and the information providers to talk directly to each other once placed into contact with each other by the real time inquiry response system. In consumer applications, this might occur where the stored inquiry response returned to the information consumer by the RTIRS includes direct contact information for a supplier of a product or service, e.g., an 800 telephone number or supplier URL, or where the information providers retrieve contact information for the consumer from the inquiry response or are sent this information directly via data link 29 by the action of the RTIRS.

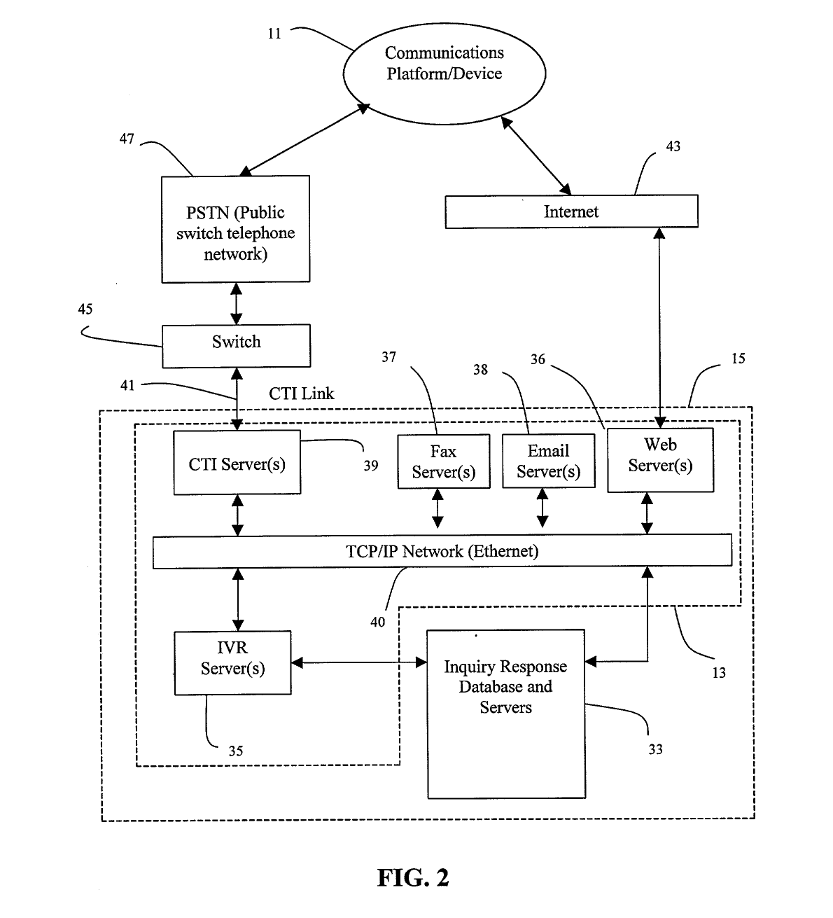

FIG. 2 is a block diagram representing a particular hardware and software implementation of the computer processing system 15 shown in FIG. 1, which includes the real time inquiry response system 13 and the inquiry response database 17 illustrated in FIG. 1.

As shown in the FIG. 2 embodiment, the RTIRS 13 includes an interactive voice response system (IVR) in the form of one or more IVR servers 35 which permit interactive voice communications with information consumers who make telephone inquiries to the system. The RTIRS also includes one or more web servers 36 to permit interactive web communications between the RTIRS and the information consumer, one or more fax servers 37 for fax communications, e-mail servers 38 for sending inquiry responses via e-mail, and computer telephony integration (CTI) servers 39. All servers are connected through a TCP/IP network 40. A CTI link 41 is provided to a switch 45 for the public switch telephone network (PSTN) 47 through which an information consumer places a call by means of a land wired or mobile telephone.

It is noted that the IVR servers 35 provide the voice-to-text and text-to-voice conversions for information consumer inquiries coming in through a telephone network while the CTI's servers direct information consumer inquiry traffic to available ports for the IVR's servers. For example, IVR's servers can serve up stored audio clips in response to a consumer inquiry related to a song or advertisement. Such audio clips can be a segment of a song and/or a voice description of a song title or artist, or an audio clip and/or description of an advertisement, or a listing of or directions to the closest retail outlets for an advertised product or service to which the inquiry pertains. It is also noted that speech to text and text to speech conversion is accomplished be conversion software that can be incorporated into the IVR or accessed through an external module. Such conversion software is also used the transformation of stored responses described later below.

Interaction between the information consumer 11 and the real time inquiry response system 13 can also be accomplished through the Internet 43 by means of the system's web servers 39 which permits inquiries to be made by the information consumer through a personal computer or wireless information devices, such as WAP telephones or personal digital assistance (PDA's).

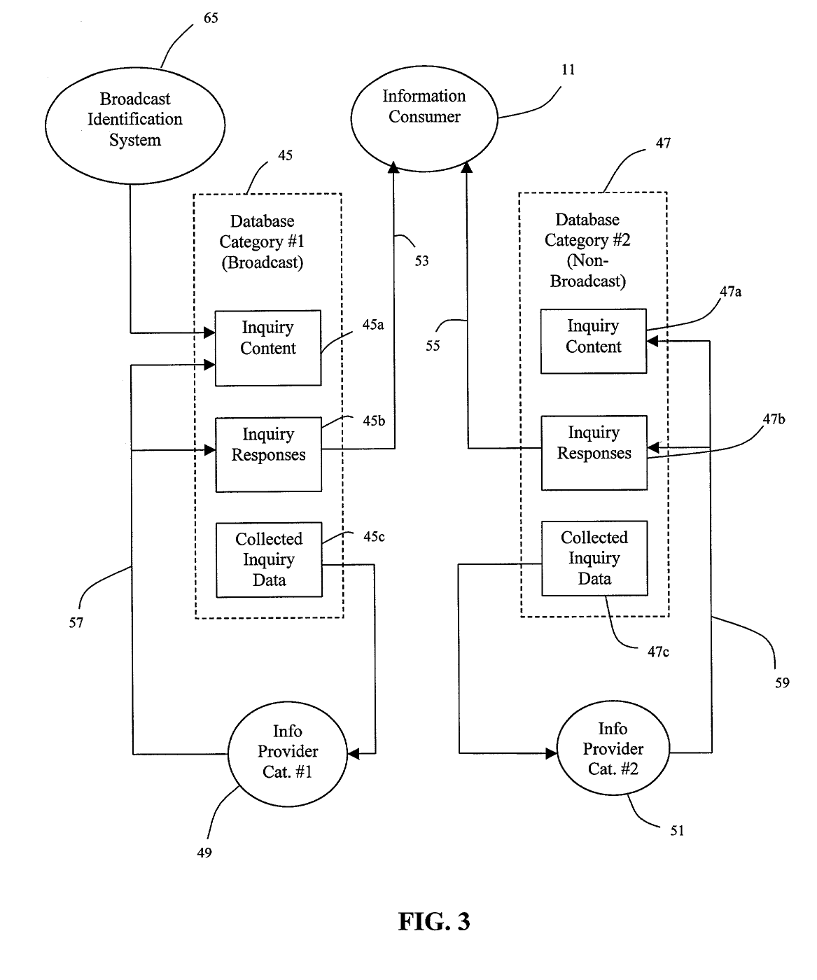

FIG. 3 illustrates a possible structure for the content of the inquiry response database for each category of information and data contained in the database. For illustrative purposes, FIG. 3 shows two categories of data and information in a consumer application, the first of which (category #1) is from a broadcast source such as broadcast music, and the other of which (category #2) relates to a non-broadcast source such as print and billboard advertisements. FIG. 3 also generally illustrates links for updating the database and retrieving information from the database by the system information providers.

The two database categories illustrated in FIG. 3, denoted by the numerals 45 and 47, each contain a inquiry content 45a, 47a, inquiry responses 45b, 47b, and collected inquiry data 45c, 47c. The inquiry content includes the demand stimulus data and information about which a consumer may inquire. For example, in database category #1 for demand stimuli produced through a broadcast media, the inquiry content 45a may include the broadcast schedules or playlists for identified broadcasters which identify music played by date and time. The inquiry responses 45b for this database category might include audio clips of the music correlated to the playlist stored as part of the inquiry content 45a, as well as voice and/or text messages identifying the music played by title and artist, or it may include video clips or graphics conveying information about the music. Other stored inquiry responses may include text messages that can be delivered to a web page or e-mail box for the consumer or to some other consumer text based communication device. Inquiry responses might further include coupons, including electronic or physical coupons sent to the consumer as hereinafter described.

Examples of the inquiry content 47a for the category #2 database for non-broadcast demand stimuli would include advertiser names, product names, pricing information, contact information, promotional information, and locations of retailers or e-tailers of products or services. Stored inquiry responses 47b for this category might include a voice message correlated to an advertiser's name and/or product name which provides information regarding the product or service, for example its availability and pricing, and stored text messages, video clips and/or graphics which can be delivered to the information consumer 11 via a communication network. The stored inquiry responses 47b of category #2 might as well include a discount coupon for a product or service delivered to the consumer. This might, for example, include sending a digital coupon to the user's wireless information device, such as a WAP telephone or PDA, which the consumer can take to a participating retailer of product or service for redemption.

The collected inquiry data 45c, 47c of database categories #1 and #2 include all information and data relating to an inquiry which is tracked, organized and compiled by the system. This would include user specific information, such as types of products and services purchased by a registered user, as well as product/service specific information such as the number of inquiries received for particular songs, or the number of inquiries received about particular products or in response to particular advertisements. By tracking inquiries regarding advertisements, advertising information providers of the system can utilize the collected inquiry data to judge the effectiveness of particular ads in specific media, for example, the effectiveness of an ad played on a specific radio station.

FIG. 3 also shows access to the databases 45, 47 by information providers 49, 51, as well as delivery of inquiry responses to the information consumers 11, as denoted by data flow arrows 53, 55. It is seen that the information providers for each of the categories #1 and #2 supply information and data to the inquiry content and the inquiry responses in the respective database categories, as denoted by data flow arrows 57, 59, and also have access to the collected inquiry data for retrieving such data as denoted by data flow arrows 61, 63. By having access to the collected inquiry data, the information providers can monitor inquiries regarding their respective goods and services on demand or on a defined schedule.

It is noted that inquiry content 45a in the broadcast database category #1 can also be supplied from a broadcast identification system described below. It is further noted that the inquiry content and inquiry responses may also be inputted manually or can be imported from another database or other data sources via a system to system interface. Also, inquiry responses can be generated from inquiry content such as a text to voice conversion of song titles, and artist names stored as part of the inquiry content.

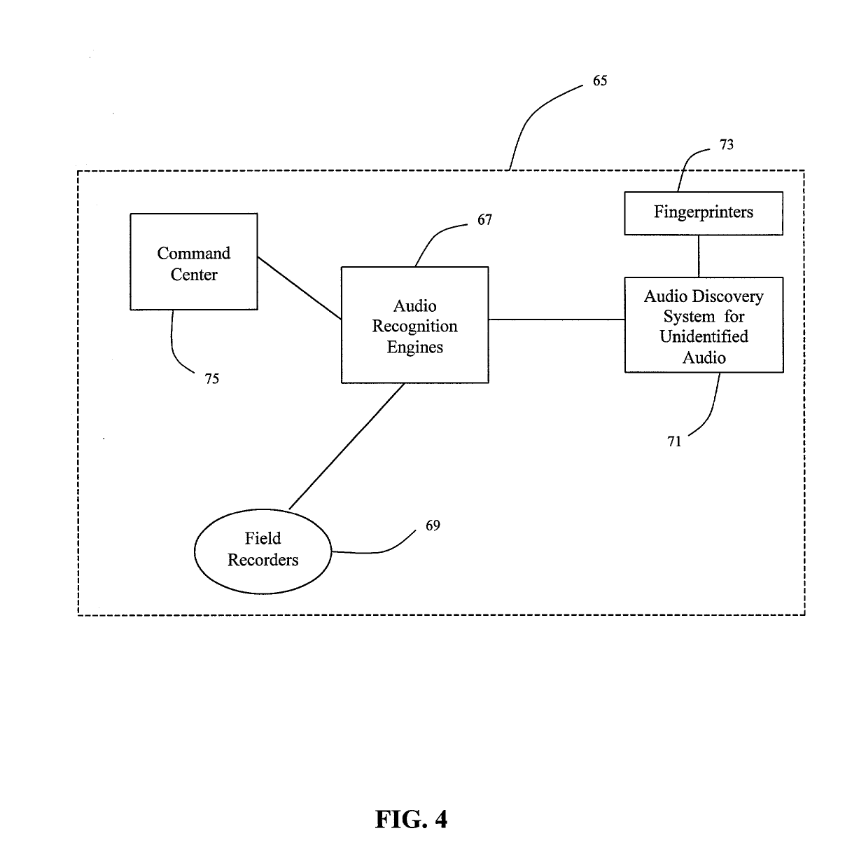

FIG. 4 illustrates a broadcast identification system by which stimulus content for the broadcast category database 45 shown in FIG. 3 can be obtained from the air waves through known broadcast signal identification systems and methods. Generally, the broadcast identification system 65 includes audio recognition engines 67 capable of identifying songs or other broadcast materials as they are being played by radio stations. The audio recognition engines identify songs received by field recorders 69 using a technique by which unique waveform characteristics or “fingerprints” of the songs are matched to the fingerprints of songs stored in a database of the audio recognition engines. Such a broadcast identification system and method is described U.S. Pat. No. 5,437,050, issued to Robert G. Lamb, et al., entitled Method and Apparatus for Recognizing Broadcast Information Using Multi-Frequency Magnitude Detection. By using such audio recognition techniques, playlists of tracked broadcasters can be built up and stored in the demand stimuli content portion of the database 45 shown in FIG. 3 without the need to obtain playlists from the broadcasters. Over time, the audio recognition engines will build up a library of broadcast songs to which future broadcasts can be matched. For broadcast songs which cannot be identified through the audio recognition engine's own library of songs, an audio discovery system is provided as represented by block 71. The audio discovery system provides unique fingerprints for a comprehensive library of songs which are entered in the library through fingerprinters 73. Block 75 generally represents a command center which controls the feeds from the various field recorders 69 to the audio recognition engines.

Once the broadcast identification system has identified a broadcast song, or other broadcast content, such as an ad, the song or ad is immediately added to the content of the inquiry response database so that inquiry responses can include information on the most currently broadcast song or ad.

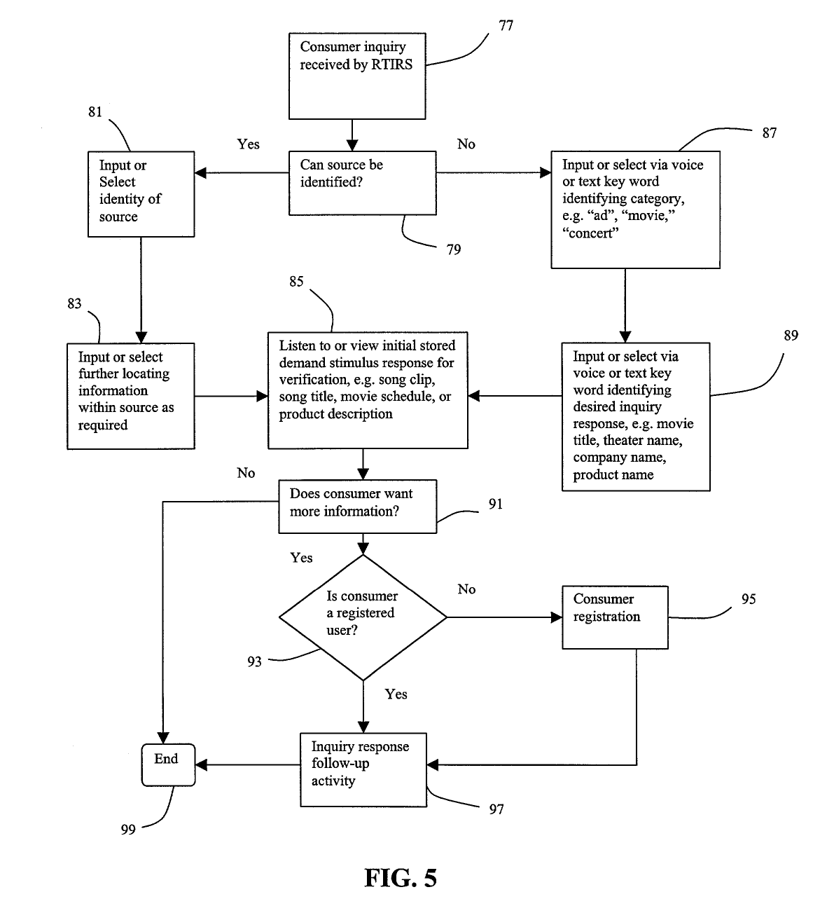

The flow charts in FIGS. 5, 6, 7 and 7A illustrate a method by which an inquiry received by the RTIRS in consumer applications can be processed in real time for different categories of inquiry responses. Referring to FIG. 5, when an inquiry is received by the RTIRS, as represented by block 77, a determination is made by an interactive communication with the information consumer whether the source of the demand stimulus can be identified (block 79). Again, an example of a source identification would be the identification of a radio station on which a song or ad were broadcast. Other possibilities might be the location of a billboard or a transit ad or an identifiable issue of a publication where an ad or other demand stimulus is seen. If a source of the demand stimulus can be identified, the information consumer is prompted to input an identification of the source or to select from a menu of source selections (block 81). For example, a consumer can be prompted to enter the call letters of a radio station on which a song is heard, or the name and date (or approximate date) of a publication in which an ad is seen. As required, the consumer can then be prompted to input or select further locating information (block 83) such as the date and approximate time a song was heard, or the product name or advertiser name in the publication previously identified. With the information supplied by the consumer, the RTIRS returns an initial stored inquiry response to the consumer for verification of his choice as represented by block 85. If a consumer is using a telephone and communicating with the RTIRS by means of interactive voice response system (IVR), inquiry responses can be in the form of one or more audio clips, such as a song clip, or a voice response which states a song title, or a product description associated with the particular inquiry made. If the consumer is communicating with the RTIRS through a personal computer or wireless information device, then the demand response can be in the form of a retrievable message which can be displayed on a computer or device screen and/or as an audio message. Depending on how the consumer is accessing the system, the message could be displayed as text, graphics or video.

If the source of the demand stimulus cannot be identified, the consumer is prompted to input or select via voice or text, depending on how the consumer is communicating with the RTIRS, a key word or words identifying the category of information in which the consumer is interested (block 87). For example, consumer may be interested in an advertisement for which a source cannot be identified, or in a movie or a concert. To access these categories, the consumer can input or select via voice or text the word “ad,” “movie,” or “concert.” Upon selecting a category, the consumer is prompted to input via voice or text, again depending on how the consumer is communicating with the system, a key word identifying the desired inquiry response, such as a movie title, theater name, company name, or product name (block 89). It is possible that blocks 87 and 89 could be collapsed into a single step where the consumer simply inputs a key word such as movie title, theater name, company name, or product name which can be indexed to a corresponding inquiry response. It is also contemplated that advertisers could provide key words which they would incorporate into their advertising and input to the inquiry response and which could be remembered by consumers for use in accessing inquiry responses associated with the ads. Once the key word or key words are entered in accordance with the steps represented by blocks 87 and 89, the consumer listens to or views an initial stored inquiry response (block 85) in the same manner as if the information were identified through a particular source.

After the consumer listens to or views the initial stored inquiry response as represented by block 85, the consumer can quit the system if no further information is desired. If the consumer wants to hear or see more (block 91), the RTIRS can take this opportunity to register the consumer as a registered user of the system (blocks 93, 95). (It is understood that a forced registration of the user, if provided, can occur at any point in the process, including immediately after the RTIRS receives an inquiry from the consumer, that is, between blocks 77 and 79.) After the consumer is registered, the system proceeds to generate inquiry response follow-up activity (block 97) as hereinafter described before quitting the system (block 99).

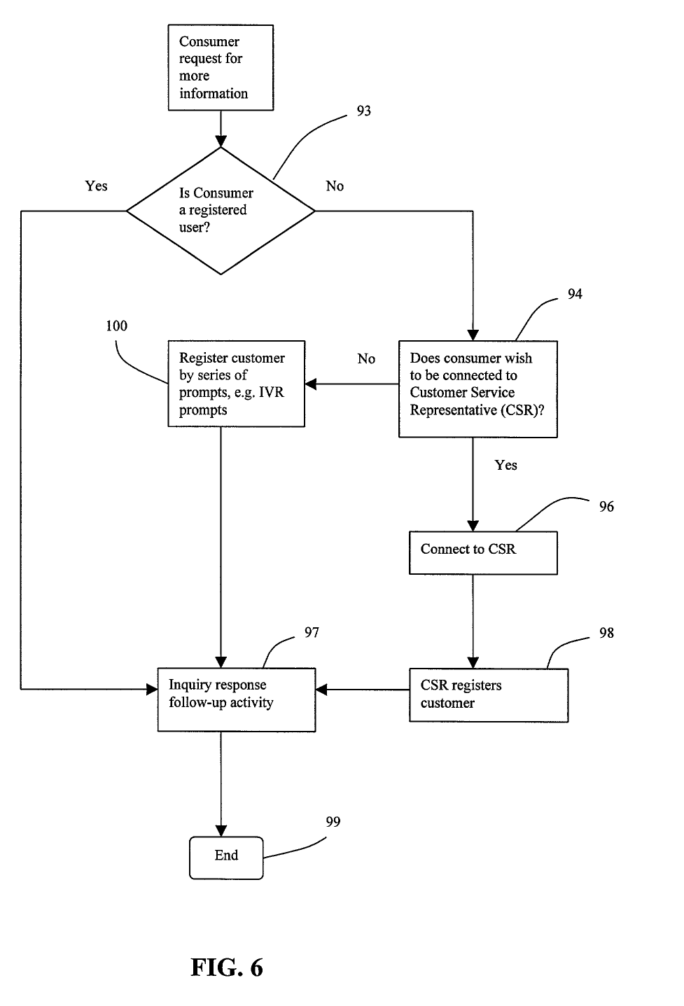

FIG. 6 illustrates the process by which the information consumer can be registered as a registered user of the system as represented by block 95 in FIG. 5. If the consumer is not a registered user, the consumer can be given a choice to be connected to a consumer service representative (CSR) or allowed to register over the phone or on-line via a series of prompts designed to elicit from the consumer the consumer's name, contact information and other desired identifying information. These registration choices are illustrated by blocks 94, 96, 98 in respect to registration through a CSR, and blocks 94 and 100 in respect to registration via on-line prompts of a web interface, or voice prompts given by an interactive voice response system. The system then proceeds to the post registration inquiry response follow-up activity represented by block 97.

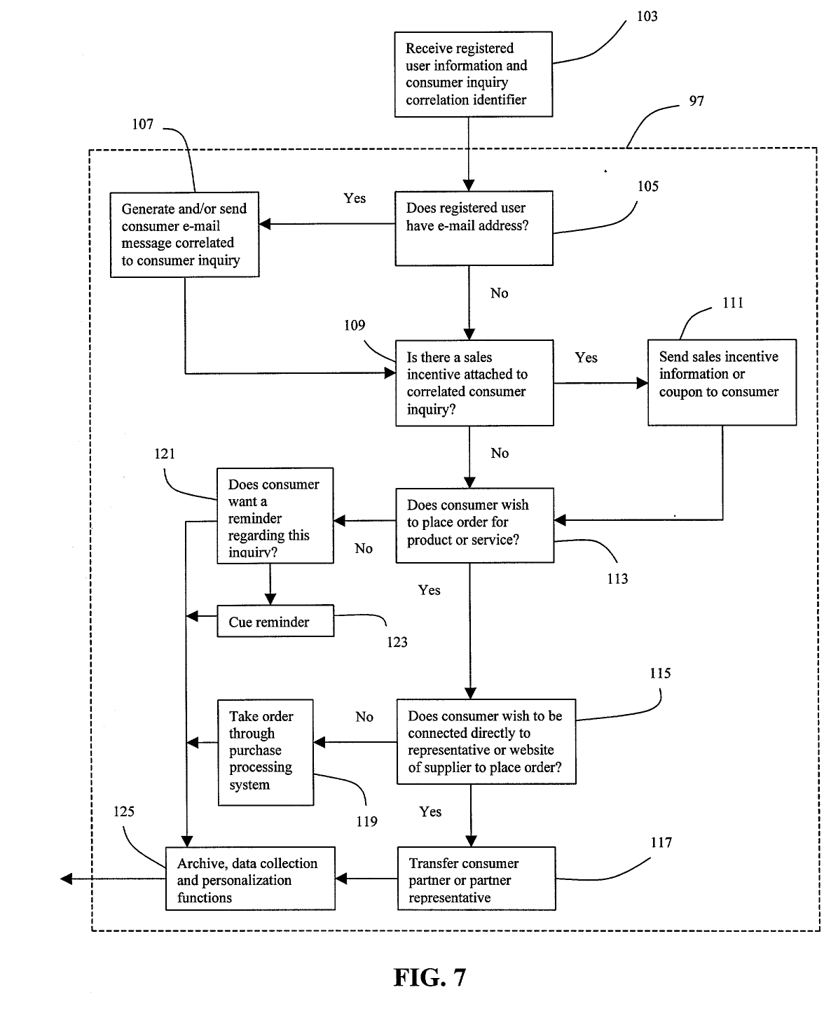

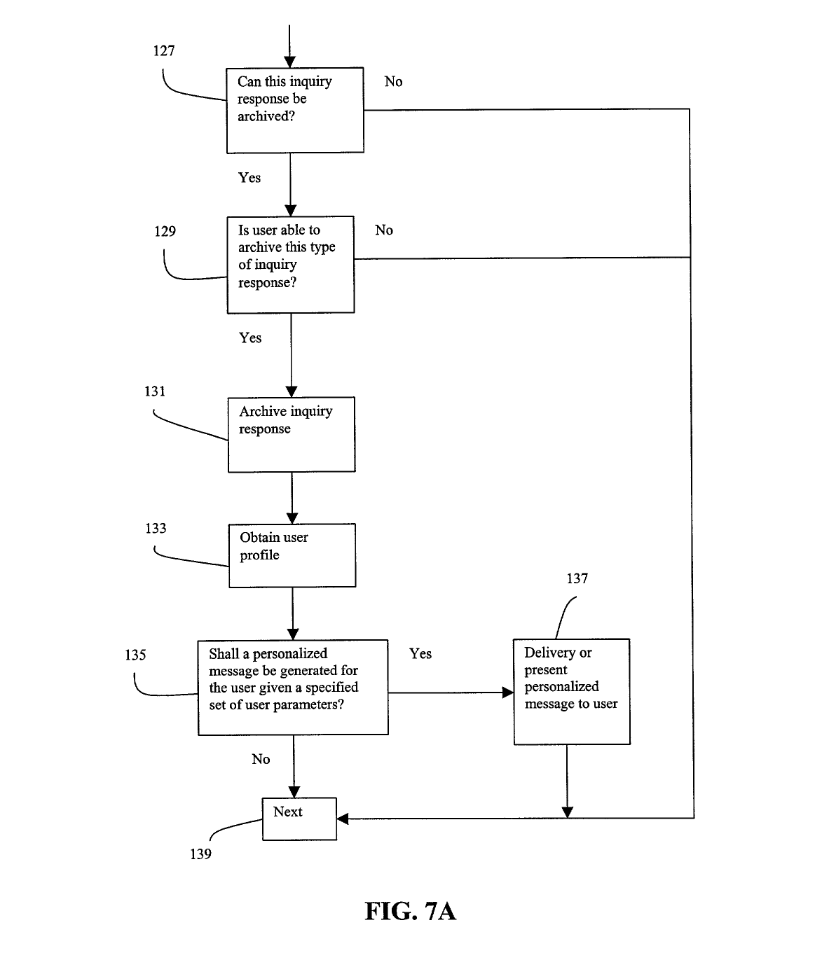

FIG. 7 graphically illustrates the types of post-registration inquiry response follow-up activity that can be performed by the RTIRS. Such activity involves a variety of possible inquiry responses sent to the consumer in response to the consumer's inquiry. It is understood that the potential inquiry responses in a particular category are not limited to the inquiry responses shown in FIG. 7, nor do the inquiry responses have to be delivered to the consumer in the order shown. It is also noted that the invention contemplates the possibility of follow-up activity being performed by the RTIRS with unregistered users, such as the possibility of capturing a consumer's phone number through an automatic number identification (ANI) system.

Referring to the flow chart illustrated in FIG. 7, the inquiry responses delivered in the inquiry response follow-up are based on registered user information and consumer inquiry correlation identifiers associated with the consumer inquiry which allow the identified consumer inquiry content to be correlated with a inquiry response or series of inquiry responses (block 103). First, the RTIRS determines whether the registered user who made the inquiry has an e-mail address (block 105) and, if so, generates and/or sends a pre-stored consumer e-mail message to the consumer at the identified e-mail address (block 107). Such an e-mail message may be a confirmation of the information delivered to the consumer by an interactive voice response system, or further information regarding the consumer's inquiry.

After the e-mail message is sent, or if the registered user has no e-mail address, a determination is made whether a special sales incentive is attached to the correlated consumer inquiry (block 109), and if so, sales incentive information or a redeemable coupon is sent to the consumer by a selected route, such as by sending a printable e-mail coupon, or by triggering the mailing of a physical coupon, or by sending an electronic or digital coupon which can be redeemed by a retailer from a wireless communication device such as a WAP telephone (block 111).

The registered user can then be asked whether he or she wishes to place an order for the product or service which is the subject of the inquiry (block 113). If yes, the consumer is given the option to be connected directly to a representative or web site of the supplier to take an order or to a customer service representative of the system operator to assist in ordering (blocks 115, 117); if no, the consumer is optionally permitted to place orders through a purchase processing system where orders are taken directly on-line or via an interactive voice response system by the RTIRS (block 119).

In another aspect to the follow-up activity, the consumer who elects not to place an order for the product or service at the time of the inquiry can elect to receive a reminder concerning the inquiry at a future date (blocks 121, 123).

In a further aspect of the follow-up activity, the RTIRS performs archive, data collection, and personalization functions (block 125) such as more particularly illustrated in FIG. 7A.

FIG. 7A illustrates process steps that can be performed by the RTIRS for archiving inquiry responses on the personal web page of a registered user or on other user devices having storage capabilities, such as PDA's, cell phones, and other wireless information devices. The flow chart of FIG. 7A also shows process steps for generating and sending a personalized message to the user.

As a first step in the flow chart of FIG. 7A, the RTIRS determines whether the inquiry response made to the user inquiry is a response for which archival will be permitted (block 127). Reasons for preventing the archival of particular responses include possible legal constraints on the copying and distribution of the information and information which has no archival value because of time sensitivity issues. Stored inquiry responses may include stored instructions directing whether archival will be permitted or not.

Assuming the inquiry response is a response capable of being archived, the RTIRS then determines whether the user making the inquiry is able to archive this type of inquiry response (block 129). This will depend on the type of interface used by the consumer to access the RTIRS and whether it is capable of archiving the responses. Archival will only be possible if the consumer has a personalized section of a website as provided by the RTIRS to which the response can be stored, or is connected to a communications device having storage capabilities. If the user is able to archive the inquiry response, the RTIRS will direct that the inquiry response be delivered to the consumer for archiving (block 131).

The RTIRS then obtains the user profile from a user profile database (block 133) and determines whether to generate a personalized message for the user making the inquiry (block 135). The generation of a personalized message is based on a set of parameters retrieved by the RTIRS, such as the user profile, the user's inquiry history, and the stored history of inquiry responses for the user making the inquiry. Such personalized messages could be additional text in an e-mailed message sent to the user which is tailored to the particular user's inquiry history and/or user profile or a banner ad triggered by particular characteristics of the user's inquiry history or profile. If the set of parameters established for generating a personalized message do not exist, no message is sent; if the set of parameters trigger a personalized message the personalized message is delivered to the user (block 137). Upon delivery of the personalized message, the RTIRS proceeds to the next step (block 139), if any, or simply quits as indicated in the flow chart of FIG. 7.

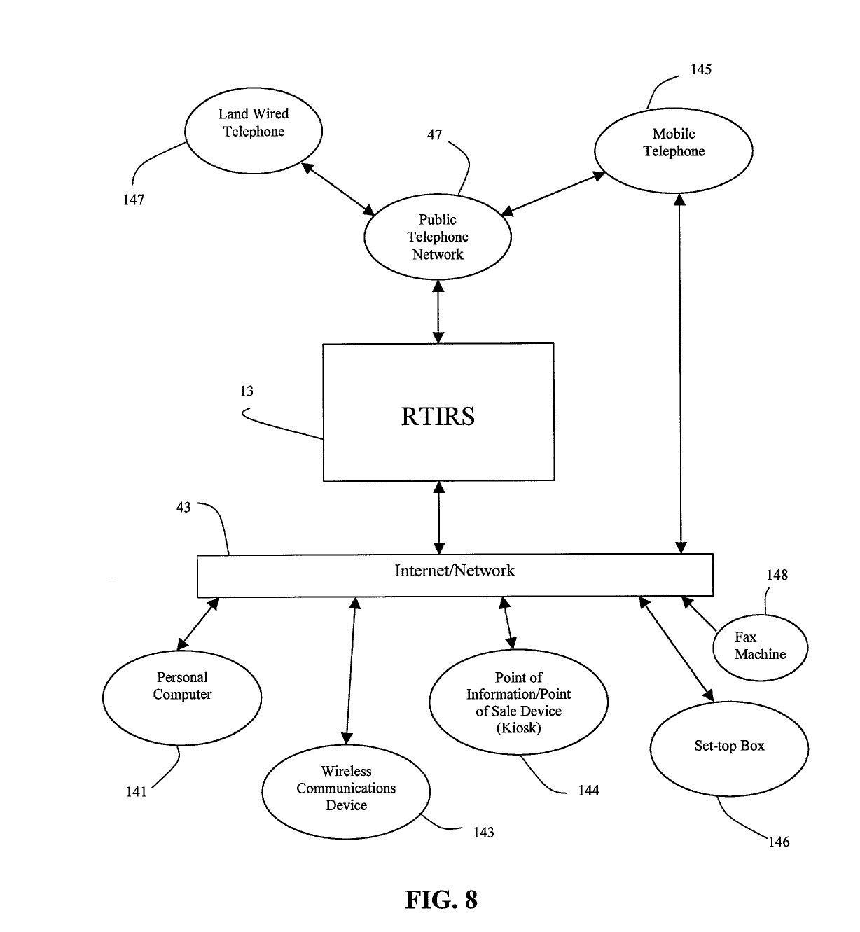

FIG. 8 provides a general conceptual overview of different interfaces from which the information consumer can interface with the real-time inquiry response system 13 of the invention. It can be seen that the RTIRS can be accessed through the Internet or other communications network 43 by a personal computer 141, any wireless information device 143, kiosk 144 supplied at accessible locations to serve as a point of information and/or point of sale device, a web-enabled mobile telephone 145, or a set-top box 146 which can be a video game console, cable box or web TV. Access can also be had through the public telephone network 47 by a land wired telephone 147 or by the wireless mobile phone 145 above-mentioned. The RTIRS is still further capable of delivering responses to a fax machine 148. Thus, it can be seen that the RTIRS can be accessed from a variety of interfaces which are web-based, accessible over a network, or based on telephone access over a public telephone network, and which include wireless interfaces which make the RTIRS easily accessible at the peak point of interest of the information consumer. For example, an information consumer having a wireless telephone, upon encountering a demand stimulus, such as a billboard ad, could call an 800 number for accessing the RTIRS, and specifically the interactive voice response system of the RTIRS. The IVR would then take the information consumer through a series of interactive voice prompts giving the consumer immediate access to the information he or she needs to make a purchase decision or decision to take some other action.

The following is an illustrative example of a sequence of IVR voice prompts and responses that can be used to step a consumer through the interactive voice response system of RTIRS for distinguishing between a song or ad category of information and for obtaining information about an ad encountered by the consumer for a fictitious airline called “Acme Airlines”:

| | |
|---|---|
| IVR: | “Please say ‘song’ to get more information about a song, say |
| | ‘ad’ to get more information about an ad.” |
| USER: | “Ad.” |
| LYR: | “Please say the key words for the ads for which you would like |
| | additional information.” OR, “Please say some words that |
| | describe the ad you are interested in.” |
| USER: | “Acme Airlines.” |

At this point, the IVR system does a speech-to-text conversion on the words spoken by the user, and then issues a request to the ad category database to perform a search for the ad key words and/or the entire text description for each ad stored in the advertisement category database. The advertisement category database will then return inquiry responses found that match the text parameters, as well as indices for retrieving specific ad information to be delivered to the consumer in any follow-up activity, such as sending the specific e-mail messages or discount coupons to the consumer.

| | |
|---|---|
| IVR: | “We found two ads that match those key words.” |

The IVR then issues a request to the advertisement category database to return the inquiry responses pointed to by the indices returned previously. The IVR then uses text-to-speech conversion to play back ad information to the consumer which comprises the inquiry response.

| | |
|---|---|
| IVR: | plays content of both ads (i.e., the inquiry responses for the ads) |
| IVR: | “In order to make it easy for you, we’ll send you information |
| | and promotional offers from Acme Airlines in an e-mail,” |
| | OR “We will send you a coupon you can use to redeem |
| | this offer at any Acme Airlines counter.” |

The IVR system then issues a request to a mail server to send out an e-mail containing the coupon to the consumer.

As an alternative, the IVR system may announce that an electronic coupon is being sent to the user's mobile phone for redemption at any Acme Airlines counter which has a data receptacle capable of receiving the coupon.

The IVR system can alternatively or additionally proceed as follows:

| | |
|---|---|
| IVR: | “Please say ‘yes’ if you would like to be transferred to an Acme |
| | Airlines agent right now to take advantage of a special offer.” |
| USER: | “Yes.” |

IVR transfers call to Acme Airlines consumer sales representative or IVR system.

The IVR may further continue as follows:

| | |
|---|---|
| IVR: | “Please say ‘purchase’ to purchase a ticket now.” |
| USER: | “Purchase.” |
| IVR: | “Please say or enter your secret pin code.” |
| USER: | “User says or enters on a key pad his or her secret pin code.” |

The IVR system can then verify that the user's ANI number or log on voice print and the user's secret pin code all match, and, if a match is detected, can issue a request to the ad database to retrieve pricing for the Acme Airlines tickets. The IVR system then can issue a request to a payment processing system to debit the user's credit card or phone bill. After the payment processing system reports a successful debit, the IVR can issue a request to send a receipt to the user and confirm the order has been processed. The receipt can be sent as an encrypted receipt to a wireless information device of the user.

The following is a further illustrative example of a sequence of IVR voice prompts and computer responses that can be used to step a consumer through an interactive voice response system of the RTIRS for distinguishing between a song and an ad category and for obtaining information about a song heard on the radio or TV:

| | |
|---|---|
| IVR: | “Please say ‘song’ to get more information about a song, |
| | say ‘ad’ to get more information about an ad.” |
| USER: | “Song.” |
| IVR: | “Please say the radio station frequency or call letters on |
| | which you heard the song.” |
| USER: | “1050” or KXOX” |

The IVR system then plays back to the consumer station ID information corresponding to the station frequency or call letters and continues:

“If this is not the station you are looking for, please say ‘wrong station’.” If user says “wrong station,” the IVR system takes the user back to the previous prompt. If not, the IVR system continues:

| | |
|---|---|
| IVR: | “Here is what just played.” |

The IVR system plays song clip of last song played, and gives user a voice message stating the song title and artist name, and then continues:

| | |
|---|---|
| IVR: | “Say ‘yes’ if this is the song you are looking for. In order to |
| | make it easy for you, we will send you an e-mail with more |
| | information regarding this song.” |
| USER: | “Yes.” |

If the user says “no,” the IVR can step the user back through previously played songs corresponding to the broadcaster's playlist and/or invite the user to specify the approximate time and date the song was played.

| | |
|---|---|
| IVR: | “Please say ‘purchase’ if you would like to purchase this |
| | song or album right now.” |
| USER: | “Purchase.” |

The IVR system here issues a request to the database to query what format the song or album is available in for purchase, and the database returns a text description of all the formats available. The IVR then uses a text speech conversion to play back a list of available formats to purchase.

The IVR can now provide the following purchase options to the user:

| | |
|---|---|
| IVR: | “Please say ‘download’ to purchase a digital download, |
| | say ‘CD’ to purchase a physical CD.” |
| USER: | “Download.” |
| IVR: | “Please say or enter your secret pin code.” |
| USER: | Says or enters secret pin code. |

The IVR system then processes the order and acknowledges the purchase to the user. If the user says “CD,” the IVR system will issue a request to the database to query prices for the song or album from different retail outlets and a text price list can be returned to the IVR whereupon the IVR can provide a voice playback of the price list to the user via text-to-voice conversion, for example, “This CD is available from ABC Records for $10, and XYZ Records for $12.” The IVR system can then continue:

| | |
|---|---|
| IVR: | “Say ‘ABC’ to purchase from ABC Records, ‘XYZ’ to purchase |
| | from XYZ Records.” |
| USER: | “ABC.” |
| IVR: | “Say ‘yes’ to check the availability of this CD from the closest |
| | ABC Records store.” |
| USER: | “Yes.” |

Here the closest ABC Record store can be obtained from further information obtained from the user through a series of suitable voice prompts or, if the user has a mobile phone or other wireless device with a global positioning system (GPS) transceiver, the IVR can retrieve the user's coordinates via the GPS transceiver to determine the location of the closest ABC Record store. The IVR system can then continue:

| | |
|---|---|
| IVR: | “The ABC Record store closest to your current location is |
| | 100 Main Street, they have the CD in stock, say ‘purchase’ to |
| | purchase this CD from this ABC Record store.” |
| USER: | “Purchase.” |

The IVR system can then process the user's order in a manner similar to the examples given above. The IVR could also give the user directions to the nearest ABC Record store.

Each of the foregoing illustrative examples contemplates that the supplier of the goods or services are information providers of the system and supply the content database with the data needed to provide the inquiry responses retrieved by the RTIRS.

FIG. 9 provides an example of how an inquiry might be processed in an enterprise application as opposed to the consumer applications described above. In FIG. 9, an inquiry response database 160 is divided into three categories of stored inquiry responses relating, respectively, to sales force automation (SFA), enterprise resource planning (ERP), and supply chain management (SCM), with the SFA category being further divided into subcategories “Sale Account Information,” or “Sales Opportunity Information,” or “Sales Account Information” (blocks 162, 164, 166), and the ERP being further divided into subcategories “Inventory Levels” or “Product Ship Dates” (blocks 168, 170). The SCM category of stored inquiry responses is not sub-divided and is represented by block 172 for “Source Material Availability Dates.” It shall be understood that the enterprise categories of stored inquiry responses shown in FIG. 9 are for illustrative purposes only, and that the organization of the inquiry response database 160 and the types of information included in the database can be designed in any fashion that meets the needs of the enterprise adopting the system. It shall also be understood that the system can be adapted to most any type of enterprise requiring on-demand information, which include both providers of goods and services.

As in the consumer application, the enterprise user enters the system through the RTIRS. After an inquiry received by the RTIRS (block 150), the user is stepped through a suitable login process (block 152), which may require that the user input a password. Following login, the user is prompted to input or select via voice or text, depending on how the user is communicating with the RTIRS, a key word or words identifying the category of information in which the user is interested (block 154). For a category of information involving sales force automation (SFA) the user might input “Sales” or “I need sales information.” For ERP, “Product” or “I need product information” might be the key words, while for the SCM category user it can be “Supplier” or “I need supplier information.” Once the key word or words have been inputted, the RTIRS directs the inquiry according to the designated category. In the case of an SCM or ERP inquiry the user can again be prompted to input or select via voice or text a key word or words identifying the desired sub-category of stored responses (blocks 156, 158). For example, in the case of an SCM inquiry the user in response to a further prompt can provide inputs such as “Sales Account,” or “Sales “Sales Account,” or “Sales Opportunity” followed by an input that identifies the target account (e.g customer name and/or product name.) The system is programmed to recognize and to retrieve the stored response correlated to the inquiry from the designated sub-category of stored responses. Similarly, in the case of an ERP inquiry the user, in response to a further prompt, can provide inputs such as “Inventory Levels” or “Product Ship Dates” followed by an input that identifies the desired target product and shipping schedule (e.g product name and/or “ship to” customer name.). The system then retrieves the stored response from one of the corresponding sub-categories of stored inquiry responses 168, 170 pertaining to the ERP category based on the user provided information. It is noted that an SCM inquiry at the first prompt level (block 154) does not provide for a second prompt with further sub-categories. In this case the key word “Supplier” can be simply followed by the name of the supplier and/or part or material description to retrieve stored responses relating to the availability of the parts or materials.

Once an inquiry is processed, the stored inquiry response is returned to the user through the RTIRS (block 174). As in the consumer model, the inquiry can be returned to the device from which the inquiry is made and to other devices, such as returning an audio response to a users cell phone and an e-mail response to an e-mail address provided by the user or contained in a stored profile for the user. Also, responses sent through different channels can be different, for example, an e-mail response may provide more information than the response to the cell phone so that, when time permits, the user can later pull up and retain for future reference more complete information relating to his or her inquiry. Further, as described in connection with the consumer model described above, profiles of users of the system can be stored to trigger particular responses that depend on the stored profile information. For example, a sales representative of a company may have a stored profile that triggers the return of a product promotion based on stored profile criteria such as territory or customer base.

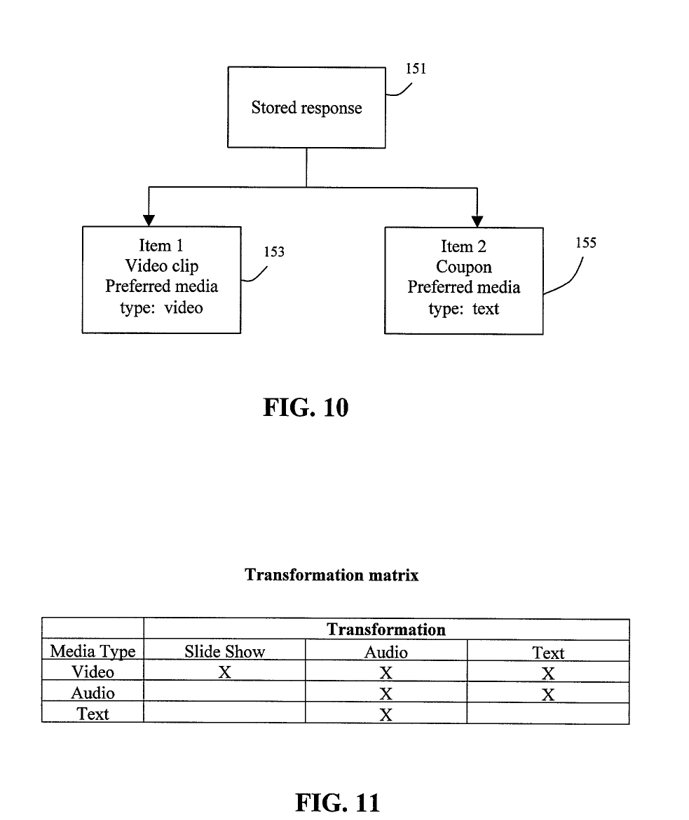

FIG. 10 shows how, in accordance with the invention, a stored inquiry response 151 can include or be associated with one or more items 153, 155 which can be delivered to the information consumer in response to an inquiry to which the stored response is related. Each item associated with the stored response will be of a particular media type, such as video, an order sequence of static graphic images (e.g. slide show), a single graphic image (e.g. a map), audio, and text. In respect to video, the video media type might be video only or video synchronized with an audio track. Each item of the response can also be of the same media type or of different media types suitable for delivery to different communications devices and communications interfaces. For example, the stored response for an inquiry about a new movie could include the following returnable items: a video clip suitable for delivery to devices and interfaces that support video, and a text coupon for discounts on movie tickets which can be delivered to devices and interfaces that do not support video.

As shown in FIG. 10, each item 153, 155 of the stored response 151 is of a preferred presentation media type, which is the media type that would most effectively present the content of the stored response. For example, where an item of a stored response is driving directions, the preferred presentation media type would be audio if the objective is to provide directions to a driver who must keep his or her eyes on the road. In such an environment, audio is a more effective presentation media type than text.

It is possible that the media type of a item of a stored inquiry is not the preferred media type for a particular inquiry or a suitable media type for delivery to a particular communications device or communications interface. In such cases, it is possible to transform the stored item of the inquiry response from its original media type to a new media type. Using the driving directions example above, the item of the stored response may be stored as an audio response which can be delivered, for example, to the driver's cell phone through an IVR system as above described. On the other hand, it is possible for the driver may wish to retrieve the directions in text format on a hand-held wireless information device, such as a Palm Pilot™.

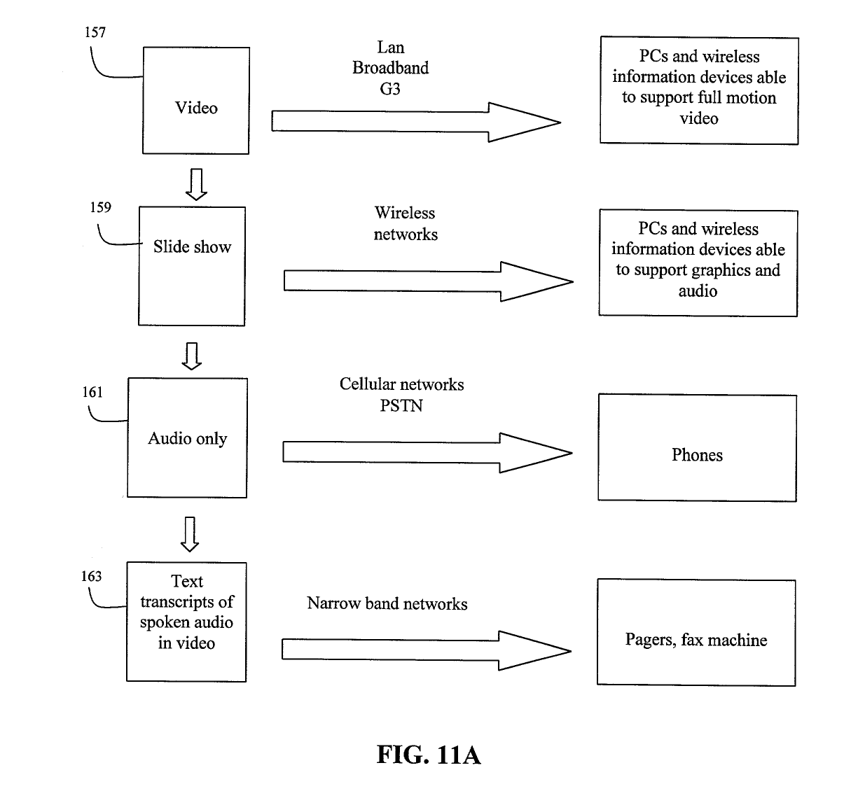

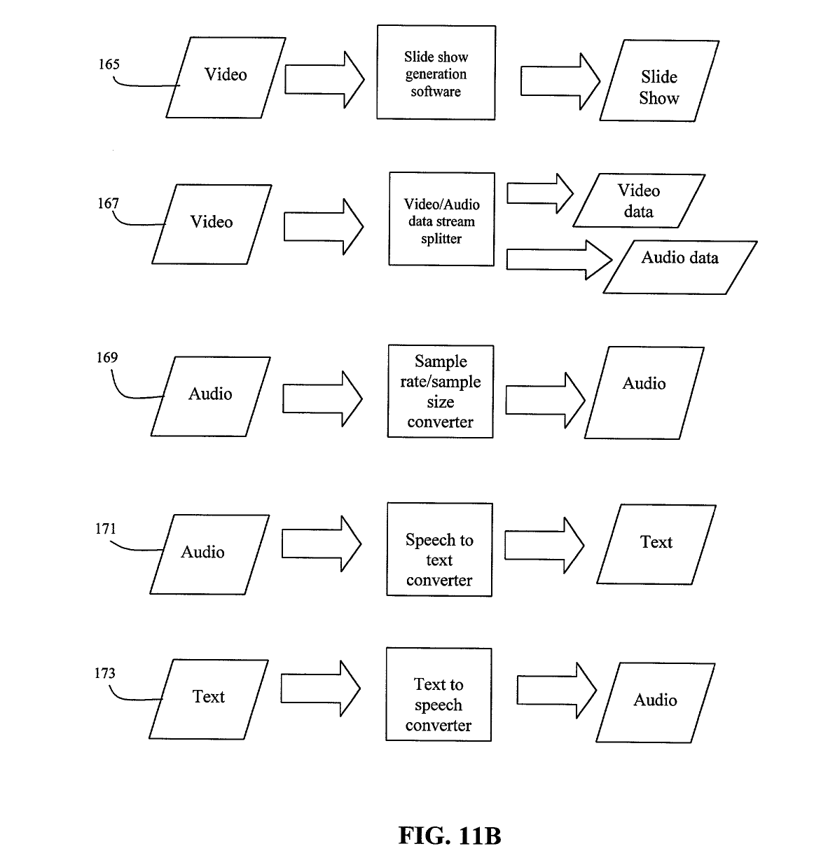

FIG. 11 illustrates a transformation matrix indicating possible transformations of different media types in accordance with the invention. Referring to this figure, it can be seen that where a stored item of the stored inquiry response is video, such as a video clip of a movie, possible transformations include transforming the video clip to a slide show, to audio only, or to text. If the stored media type is audio, such as the speaking of driving directions, a possible transformation of this media type is from audio to text, so that, for example, the driving directions can be printed out in text form. (Another possible transformation is from high fidelity audio to a lower fidelity audio to permit the response to be delivered over a narrower band network.) If, on the other hand, the stored item of the inquiry response is in text format, the possible transformation is from text to audio. Such transformations not only permit the return of responses to different communications devices and through different communications interfaces, but it also allows for the immediate delivery of a stored response, regardless of the media format in which it is stored.

Transformations of media types are further described in reference to FIG. 11A, which illustrates a transformation hierarchy based on the types of communication devices used to retrieve information from a system. A stored item of a inquiry response can go through a single or multiple transformations as required to adapt the returned stored response to the communications device and channels of communication used to send the inquiry.

Referring to FIG. 11A, it can be seen that inquiry responses in a video format 157 are suitable for delivery over LAN, G3, and other broadband communication networks to such devices as personal computers and wireless information devices able to support full-motion video. Where the inquiry is made through broadband networks from such communication devices, no transformation is required.

When inquiry response are to be delivered through wireless networks to devices such as personal computers and wireless information devices able to support graphics and audio, but not full-motion video, the stored inquiry response in the video format can be transformed to a slide show 159. With this transformation the inquiry response is delivered in the form of one or more static graphic images. Various delivery options for a slide show are possible, such as: 1) delivering images synchronized with the audio or text associated with the video, depending on user preferences and retrieval device capabilities; 2) delivering images presented according to a user configurable schedule; or 3) delivering a number of images in a slide show adjusted according to the device and delivery mechanism capabilities.

Where the inquiry is made over a cellular phone network or land wired telephone network, the stored response is transformed down to an audio only media type 161. This transformation acts to simply output the audio stream from the stored video clip. With such a transformation, the response can be heard on a device that supports audio only.

Where the inquiry is made over a narrow band network, such as from a pager, or where delivery of the inquiry response is made to a fax machine, the audio track of the video is further transformed down to text 163, such that text transcripts of the spoken audio in the stored video can be delivered to the retrieval device.

FIG. 11B graphically illustrates the hardware and software applications that can be used to transform one media type to another. Referring to FIG. 11B, it can be seen that an item of an inquiry response stored in a video format can be transformed to a slide show by commercially available slide show generation software. (Transformation 165) Where a video media type having an audio track is to be transformed to an audio only media type (or to a video only media type) a video/audio data stream splitter can be used. (Transformation 167)

In the case of items of an inquiry response which are stored in an audio format, the audio media type can be transformed to a new audio format, for example, one with lower fidelity requiring less bandwidth for delivery, by a sample rate or sample size converter. (Transformation 169) Where audio is converted to text, the transformation is accomplished by a speech to text converter. (Transformation 171) Finally, where the item of the stored response is stored in a text format, the media type can be transformed to audio by means of a text to speech converter. (Transformation 173) All transformations can be accomplished by commercially available software.

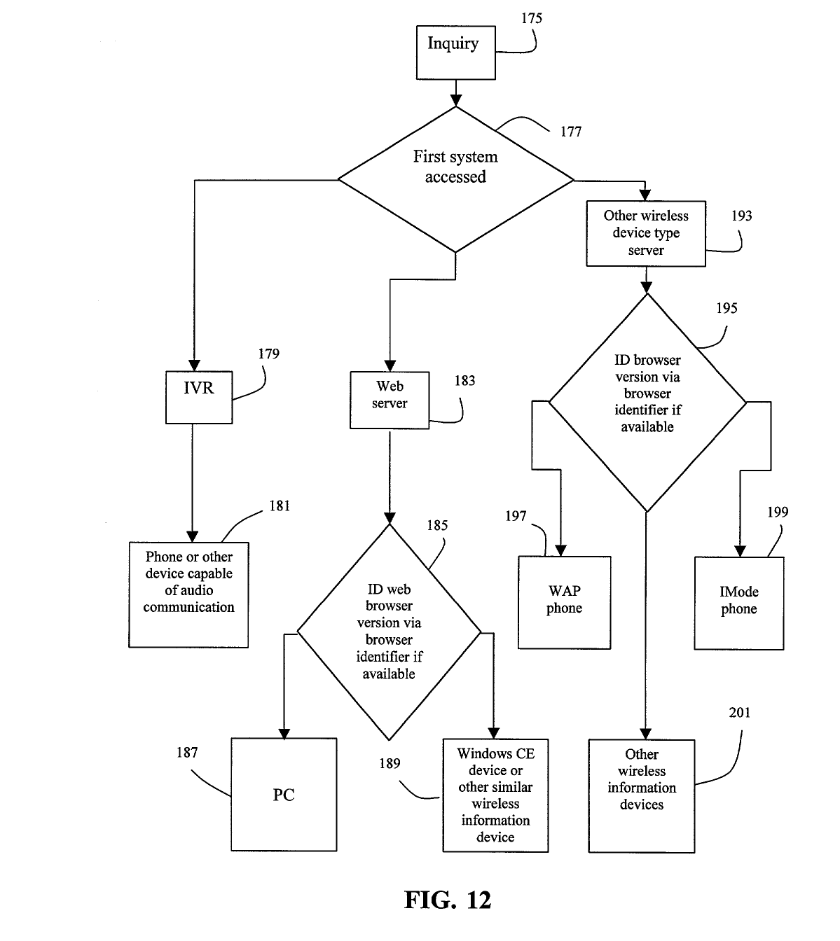

FIG. 12 is a flow chart that generally illustrates the process by which the real time inquiry response system identifies the communications platform and communications device from which the inquiry (block 175) from the information consumer is sent. This process is generally seen to depend on which communications system of the RTIRS is accessed by the inquiry (block 177), the interactive voice response system (IVR), the web server, or another device server. If the inquiry comes into the IVR (block 179), the system knows that the inquiry is made by voice interface and that the device used is a telephone or some other device capable of an audio communication such voice or music (block 181). If the inquiry comes to the web server (block 183), the system knows that the communications platform from which the inquiry is made is a web or WAP browser. The web or WAP browser will identify itself during an inquiry. If a browser identifier is available, the web browser version can be identified (block 185). By mapping the identified browser version with devices capable of running the browser, the system can identify the device type from which the inquiry is sent and determine the capabilities of the device. For example, if the web server thinks that an inquiry is being received from an information consumer using Internet Explorer™ or Netscape Navigator™, the system will identify the device as a personal computer (block 187). On the other hand Windows CE™ or devices that support this browser type might instead be detected (block 189). In addition to identifying the platform being used, the system can derive from the identifier transmitted by the browser the capabilities of the application being run on the device, which will permit the system to determine whether the browser can support streaming video.

The first system accessed may yet be another type of wireless device server (block 193) where again the browser is identified if possible (block 195). For example, if an OpenWave™ browser is detected, the system will identify the communications device as a web-enabled phone (block 197). Similarly, an Imode phone (block 199) or other wireless information device (block 201) might be detected.

As noted above, that the RTIRS preferably has the capability of receiving an inquiry through one type of communication device, such as a telephone, and returning a response to another platform or device such as sending a response to the inquiry via e-mail through the RTIRS e-mail server to the information consumers provided e-mail address. As also noted, the RTIRS preferably allows inquiry responses to be returned through more than one response channel. Thus, different items of a stored response can be delivered to different communication devices at the same time. (Different items of a stored response could also be returned to the same communications device.) For example, an inquiry about a movie from a PC could cause the RTIRS to return a video clip of the movie to the PC, while in addition sending a discount coupon to the inquirer's e-mail address.

Therefore, it can be seen that the present invention provides a system and method for readily providing on demand responses to inquiries from information consumers through a variety of different interfaces and devices by which the information consumer can access information in real time, including access over a public telephone network or the Internet or other communications network. While the invention has been described in considerable detail in the foregoing specification, it will be understood that it is not intended that the invention be limited

What we claim is:

1. A system for providing on-demand responses to inquiries made by information consumers using a variety of communication interfaces and communication devices, comprising
a database having a plurality of stored responses corresponding to inquiries made by an information consumer, each said stored response containing at least one stored item returnable to an information consumer in response to an inquiry, said returnable item being of a preferred presentation media type that most effectively presents said returnable item,
an real time inquiry response system for receiving inquiries submitted by an information consumer from a device having a communications interface,
means for correlating consumer inquiries received by said real time inquiry response system with inquiry responses stored in said database,
device-interface identification means for identifying the communications interface and communications device from which the inquiry from the information consumer is sent, and
stored item return means associated with said real time inquiry response system for determining whether the media type for the at least one stored item of said inquiry response is compatible with the communications interface and communications device from which the inquiry is made, and for returning the item of the stored response to a communications device with a communications interface which is compatible with the media type of the item of the stored inquiry response.

2. The system of claim 2 wherein said real time inquiry response system further comprises media type transforming means cooperative with said stored item return means for transforming the preferred media type of the stored item of the stored inquiry response to a different transformed media type in response to an inquiry requiring the presentation of the item of the stored response in the transformed media type.

3. The system of claim 2 wherein said media type transforming means is responsive to the identification means when said identification means identifies a communications interface or communications device from which an inquiry is sent which is not compatible with the preferred media type of the item of the stored inquiry response, said transforming means acting to transform the preferred media type of said item into a transformed media type which is compatible with the communications device and communications interface from which the inquiry is sent.

4. The system of claim 2 wherein the preferred media type for the item of said stored response is a video media and wherein said media type transforming means acts to transform the video media to a static graphic image media.

5. The system of claim 2 wherein the preferred media type for the item of said stored response is a video media and wherein said media type transforming means acts to transform the video media to a media type comprised of an ordered sequence of static graphic images.

6. The system of claim 2 wherein the preferred media type for the item of said stored response is a video media with an audio track and wherein said media type transforming means acts to transform the video media with an audio track to an audio only media.

7. The system of claim 2 wherein the preferred media type for the item of said stored response is an audio media and wherein said media type transforming means acts to transform the audio media to a text media.

8. The system of claim 2 wherein the preferred media type for the item of said stored response is a text media and wherein said media type transforming means acts to transform the text media to an audio media.

9. The system of claim 2 wherein the preferred media type for the item of said stored response is selected from a group consisting of video, static graphic image, an ordered sequence of static graphic images, audio and text media, and wherein said media type transforming means acts to perform transformations selected from a group consisting of a video to static graphic image media transformation, a video to an ordered sequence of static graphic images transformation, a video with audio to audio only media transformation, an audio to text media transformation, and a text to audio media transformation.

10. The system of claim 1 wherein said stored responses include stored responses having at least two stored items returnable to an information consumer in response to an inquiry, each of said stored items being of a preferred presentation media type that most effectively presents said returnable item, and wherein the stored item return means of said computer processing system determines whether the media type for the stored items of said inquiry response is compatible with the communications interface and communications device from which the inquiry is made, and returns the item of the stored response to a communications device with a communications interface which is compatible with the media type of such item.

11. The system of claim 10 wherein at least two stored items of said stored response have different preferred media types, and wherein said computer processing system further comprises means associated with said real time inquiry response system for selecting the items of the stored response which are the most compatible with the communications interface and communications device from which the inquiry is made, said inquiry response system returning only those items to the communications device which are the most compatible therewith.

12. The system of claim 11 wherein the one item of the stored response is of a video media type and another item of the stored response is of a static graphic image media type.

13. The system of claim 11 wherein one item of the stored response is of a video media type and another item of the stored response is of an audio media type.

14. The system of claim 11 wherein one item of the stored response is of a video media type and another item of the stored response is of a text media type.

15. The system of claim 11 wherein one item of the stored response is of an audio media type and another item of the stored response is of a text media type.

16. The system of claim 11 wherein the media types for the at least two items of said stored response are different media types selected from a group consisting of video, a static graphic image, ordered sequence of static graphic images, audio and text media types.

17. A system for providing on-demand responses to inquiries made by information consumers using a variety of communication interfaces and communication devices, comprising
a database having a plurality of stored responses to inquiries made by information consumers, each said stored response containing at least two stored items returnable to an information consumer in response to an inquiry, each said returnable item being of a preferred presentation media type that most effectively presents said returnable item,
a real time inquiry response system for receiving inquiries submitted by an information consumer from a device having a communications interface and for returning the at least one returnable item of said stored response to the communications device,
correlating means for correlating consumer inquiries received by said real time inquiry response system with inquiry responses stored in said database,
identification means for identifying the communications interface and communications device from which the inquiry from the information consumer is sent,
stored item return means associated with said real time inquiry response system for determining whether the media type for the at least one stored item of said inquiry response is compatible with the communications interface and communications device from which the inquiry is made, and for returning the item of the stored response to a communications device with a communications interface which is compatible with the media type of the item of the stored inquiry response, and
media type transforming means cooperative with said stored item return means for transforming the preferred media type of the stored item of the stored inquiry response to a different transformed media type, said media type transforming means being responsive to the identification means when said identification means identifies a communications interface or communications device from which an inquiry is sent which is not compatible with the preferred media type of the item of the stored inquiry response, said transforming means acting to transform the preferred media type of said item into a transformed media type which is compatible with the communications device and communications interface from which the inquiry is sent.

18. The system of claim 17 wherein the media types for the at least two items of said stored response are different media types selected from a group consisting of video, static graphic image, ordered sequence of static graphic images, audio and text media types, and wherein said computer processing system further comprises means associated with said real time inquiry response system for selecting the items of the stored response which are the most compatible with the communications interface and communications device from which the inquiry is made, said inquiry response system returning only those items to the communications device which are the most compatible therewith.

19. The system of claim 18 wherein one item of the stored response is of a video media type and another item of the stored response is of a static graphic image media type.

20. The system of claim 18 wherein one item of the stored response is of a video media type and another item of the stored response is of an audio media type.

21. The system of claim 18 wherein one item of the stored response is of a video media type and another item of the stored response is of a text media type.

22. The system of claim 18 wherein the one item of the stored response is of an audio media type and another item of the stored response is of a text media type.

23. The system of claim 18 wherein the media types for the at least two items of said stored response are different media types selected from a group consisting of video, static graphic images, an ordered sequence of static graphic images, audio, and text media types.

24. The system of claim 17 wherein the preferred media type for at least one item of said stored response is a video media and wherein said media type transforming means acts to transform the video media to a static graphic image media.

25. The system of claim 17 wherein the preferred media type for the item of said stored response is a video media and wherein said media type transforming means acts to transform the video media to a media type comprised of an ordered sequence of static graphic images.

26. The system of claim 17 wherein the preferred media type for at least one item of said stored response is a video media with an audio track and wherein said media type transforming means acts to transform the video media with an audio track to an audio only media.

27. The system of claim 17 wherein the preferred media type for at least one item of said stored response is an audio media and wherein said media type transforming means acts to transform the audio media to a text media.

28. The system of claim 17 wherein the preferred media type for at least one item of said stored response is a text media and wherein said media type transforming means acts to transform the text media to an audio media.

29. The system of claim 17 wherein the preferred media type for at least one item of said stored response is selected from a group consisting of video, static graphic image, an ordered sequence of static graphic images, audio and text media, and wherein said media type transforming means acts to perform transformations selected from a group consisting of a video to a static graphic image media transformation, a video to an ordered sequence of static graphic images transformation, a video with audio to audio only media transformation, an audio to text media transformation, and a text to audio media transformation.
